(19) United States
(12) Patent Application Publication
(10) Pub. No.: US 2004/0172660 A1
(43) Pub. Date: Sep. 2, 2004

(54) Impedance-matched interface for broadband data service provisioning

(75) Inventors: Celite Milbrandt, Austin, TX (US); Saf Asghar, Austin, TX (US); Richard Bruce Webb, Austin, TX (US)

Correspondence Address: HAMILTON & TERRILE, LLP, P.O. BOX 203518, AUSTIN, TX, 78720, US

(73) Assignee: Celite Systems, A Delaware Corporation, Austin, TX (US)

(21) Appl. No.: 10/376,407

(22) Filed: Feb. 28, 2003

(51) Int. Cl. H04N 7/173

(52) U.S. Cl. 725/129; 725/106

(57) ABSTRACT

A method and apparatus for provisioning broadband services to subscribers using an impedance-matched interface at a servicing area interface (SAI) that is in the same geographic vicinity as the subscriber group. Adequate signal-to-noise ratios at the subscriber site is achieved using a fraction of the power required using currently available broadband provisioning techniques. The impedance characteristics of the F1/F2 distribution lines at the SAI allow the broadband distribution system of the present invention to be deployed without the need for a POTS splitter to provide standard telephone service to the subscriber. The present invention also provides an improved coupling system to ensure that proper impedance is maintained to facilitate the operation of POTS equipment if the system components in the coupling system experience a loss of power.

### SPECIFICATION

This application is related to application Ser. No. 10/137,624, entitled Digital Subscriber Head End, filed on May 2, 2002, which by this reference is incorporated herein for all purposes.

### BACKGROUND

1. Technical Field

The present invention relates generally to broadband data communication systems. More specifically, the present invention provides an improved method and apparatus for efficient provisioning of broadband data services using an impedance-matched interface.

2. Background

Most of the current systems for providing broadband Internet access are complex and expensive to deploy. As a result, the deployment of many broadband services, particularly digital subscriber line (DSL) service, has fallen far short of expectations.

Some broadband service systems, such as DSL, are based on the same telephone subscriber loop that is used to provide “Plain Old Telephone Service (POTS)” and generally coexists with POTS service on the same twisted pair cable, offering simultaneous analog/digital services. In current systems for provisioning DSL, a digital subscriber line access multiplexer (DSLAM) is deployed at the central office (CO) and a relatively high power signal is transmitted over an F1/main feed distribution network that provides service to various subscriber groups.

Attenuation of the transmitted signal over the distribution network is a major limiting factor in providing DSL service to subscribers. As the distance between the central office and the subscriber increases, data rates drop significantly. In general, DSL data rates using current provisioning techniques are unacceptable when the distance between the central office and the subscriber exceeds 18,000 feet. There is a need, therefore, for an efficient and economical system that makes it possible to provision broadband data services beyond the distances that are possible using current deployment techniques.

### SUMMARY OF THE INVENTION

The present invention overcomes the shortcomings of the prior art by providing a method and apparatus for provisioning broadband services to subscribers using an impedance-matched interface at a servicing area interface (SAI) that is in the same geographic vicinity as the subscriber group. The system of the present invention provides a significant reduction in required power compared to conventional systems. Adequate signal-to-noise ratios at the subscriber site can be achieved using a fraction of the power required using currently available broadband provisioning techniques. In addition to the lower power requirements, the impedance characteristics of the F1/F2 distribution lines at the SAI allow the broadband distribution system of the present invention to be deployed without the need for a POTS splitter to provide standard telephone service to the subscriber. The present invention also provides an improved coupling system to ensure that proper impedance is maintained to facilitate the operation of POTS equipment if the system components in the coupling system experience a loss of power.

For purposes of illustration, some aspects of the present invention will be described in connection with a particular broadband service, such as DSL. The advantages described herein, however, can be used to reduce cost and improve performance for many other systems for providing broadband services to subscribers.

### BRIEF DESCRIPTION OF THE DRAWINGS

A better understanding of the invention can be obtained when the following detailed description of various exemplary embodiments is considered in conjunction with the following drawings.

FIG. 1 is a system diagram illustrating an embodiment of a prior art distribution area.

FIG. 2 is a system diagram illustrating an embodiment of a broadband distribution system showing the broadband service distribution equipment connected to a cross-connect box in a subscriber distribution area.

FIG. 3 is a system diagram illustrating direct tap interconnections within a cross-connect box for connecting broadband distribution equipment to provide broadband services to subscribers in the distribution area.

FIG. 4 is a general illustration of the impedances for the F1 and F2 distribution cables relative to the serving area interface cross-connection box in the subscriber distribution area.

FIG. 5 is a schematic block diagram of the equivalent impedances of the serving area interface and the F1/F2 distribution cables connected to the broadband distribution equipment, via the cross-connect box, in the subscriber distribution area.

FIG. 6 is a block diagram illustration of the connection of broadband distribution equipment to the junction of the F1/F2 distribution cables in the SAI via a coupling system that is operable to maintain proper impedance operation of POTS equipment in the event of a loss of power to the system components of the coupling system.

### DETAILED DESCRIPTION OF THE INVENTION

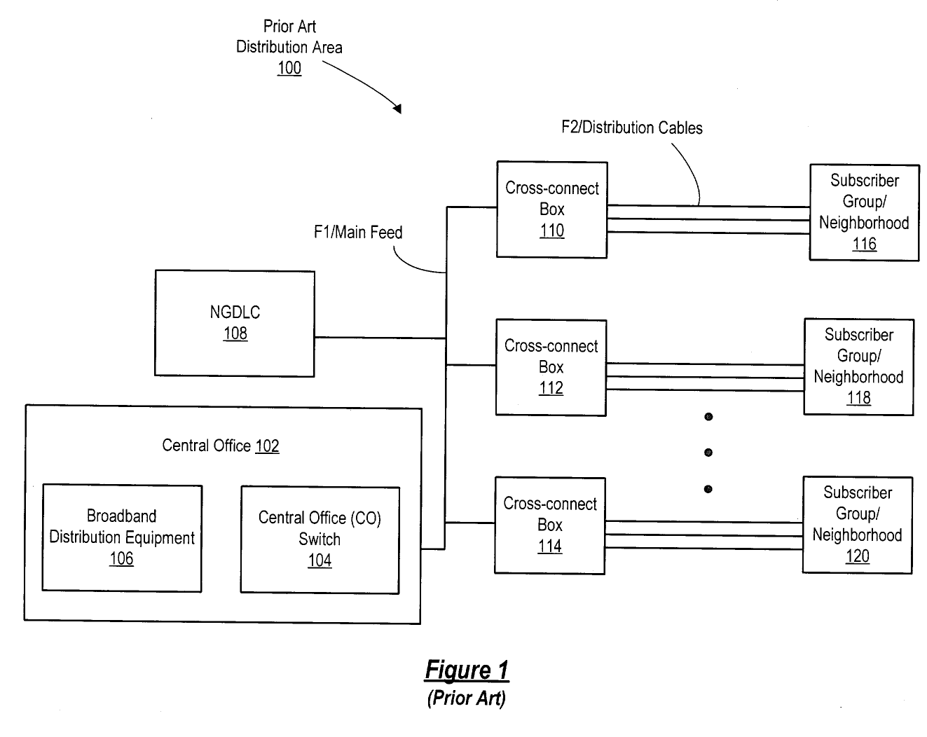

FIG. 1 is a system diagram illustrating an embodiment of a prior art distribution area 100 for providing broadband service to a plurality of subscribers. A central office 102 provides an F1/main feed distribution that may be employed to service different subscriber groups. In the illustration of the FIG. 1, the F1/main feed provides connectivity to a number of serving area interface (SAI) cross-connect boxes 110, 112, . . . and 114. Each of the cross-connect boxes 110, 112, . . . , and 114 provide servicing via F2/distribution cables to subscriber groups/neighborhoods 116, 118, . . . , and 120, respectively. One or more of the cross-connect boxes 110, 114, . . . , and 116 may employ a next generation digital loop carrier (NG-DLC) 108.

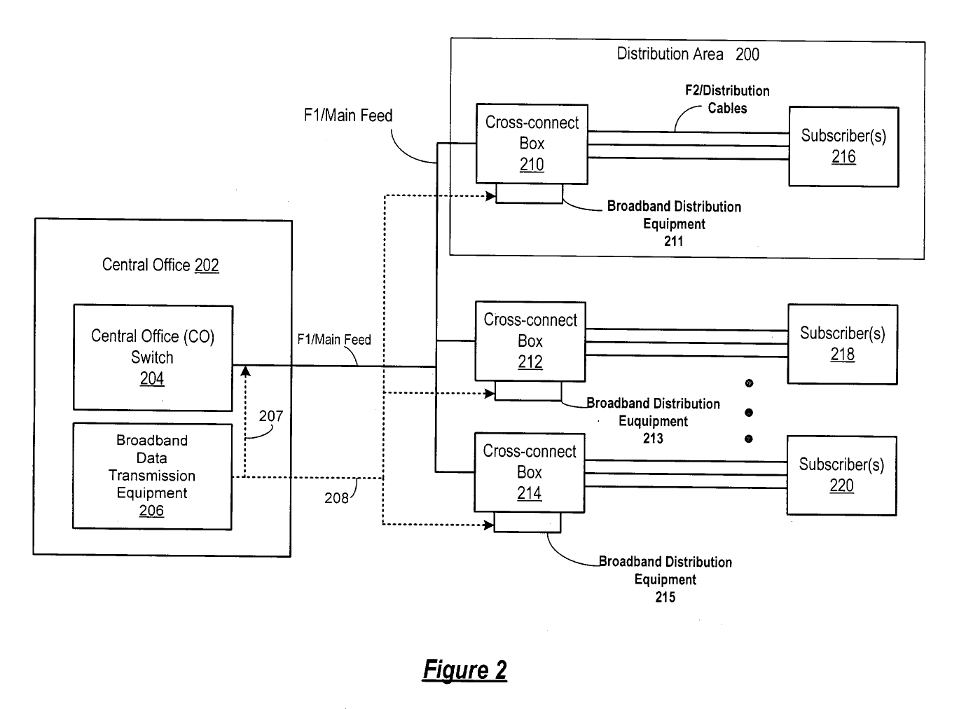

FIG. 2 is a system diagram illustrating an embodiment of a distribution area 200 that is configured in accordance with the present invention. A central office 202 provides an F1/main feed cable to distribution points within the distribution area 200. The distribution points typically include cross-connect boxes, shown as cross-connect box 210, cross-connect box 212, . . . , and cross-connect box 214. The cross-connect boxes connect the F1 main feed cables to F2 distribution cables that provide service to a large number of subscribers, shown as subscriber(s) 216, subscriber(s) 218, . . . , and subscriber(s) 220.

In the embodiment shown in FIG. 2, broadband distribution equipment is connected to each of the cross-connect boxes 210-214. For example, broadband distribution equipment 211 is attached to the cross-connect box 210. The broadband distribution equipment 211 is operable to provide broadband service to the subscriber(s) 216. As will be described in greater detail below, the interconnections of the broadband distribution equipment within each of the cross-connect boxes can be performed by “tapping off” each active F1/F2 pair within the cross-connect loop. In some embodiments, F2/distribution cable pairs are communicatively coupled to each subscriber even though only a fraction of the connections are actually used at the time the broadband distribution equipment is installed. Since the subscriber pairs are already connected, subsequent users can be provided with broadband service remotely, without the need for disrupting existing service.

By using the configuration illustrated in FIG. 2, broadband service capabilities can be offered to the subscriber(s) 216, 218, . . . , and 220 without a radical overhaul of the system's communication hardware or significant man-hours to enable those services. Moreover, the broadband service can be provided with far less power than is currently required using broadband distribution equipment that is connected to the distribution network at the central office.

Broadband signal transmission to the broadband distribution equipment 211, 213, . . . , 215 at the cross-connect boxes 210, 212, . . . , and 214 can be provided via broadband data transmission equipment 206 that can be implemented in a number of different configurations. For example, the broadband data can be transmitted to the broadband distribution equipment 211, 213, . . . , 215 using dedicated cables in the F1 main feed to transport Ti or other broadband service, as illustrated by the pathway 207. In this embodiment, a predetermined number of cable pairs in the F1 bundle are dedicated for broadband data transmission. In addition, some of the F1 cable pairs can be dedicated to provide power to the broadband distribution equipment. T he broadband data bandwidth carried over the F1 is aggregated and distributed to subscribers by the broadband distribution equipment 211, 213, . . . , 215. Alternatively, the broadband data can be transmitted to the broadband distribution equipment 211, 213, . . . , 215 using a separate transmission pathway illustrated by reference numeral 208. The separate transmission pathway can be implemented using a number of techniques known in the art, including fiber optic media or point-to-point radio transmission.

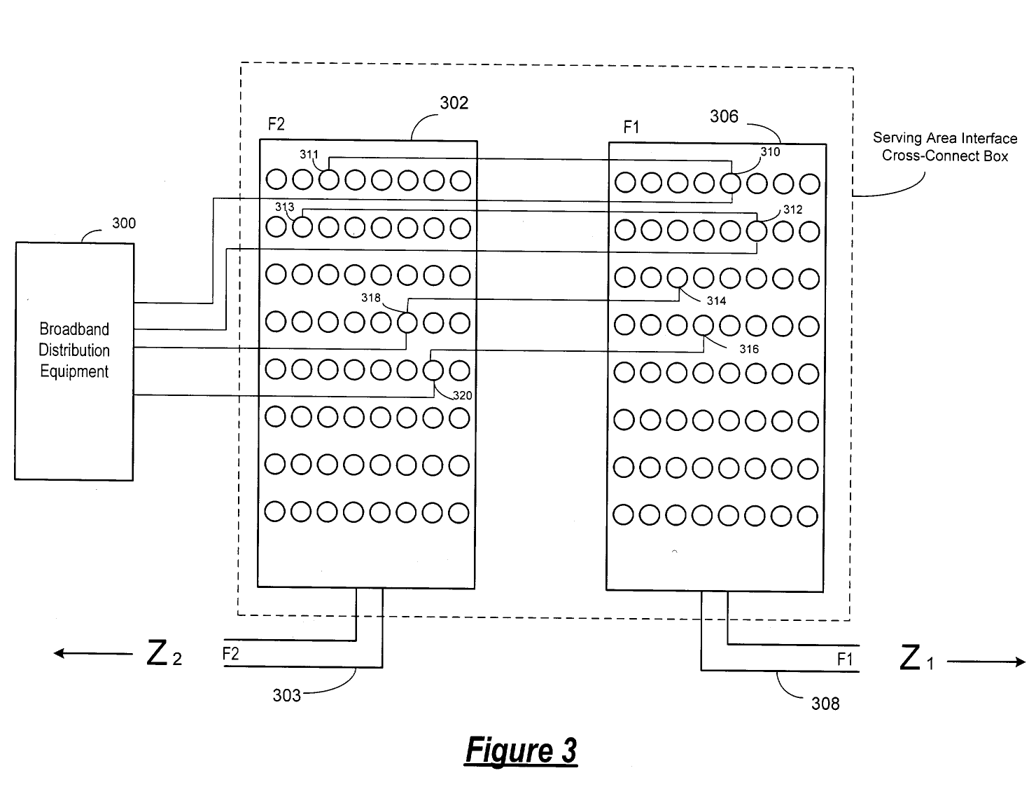

FIG. 3 is a system diagram illustrating an embodiment of interconnections between the F1 and F2 cables and the broadband distribution equipment 300. In one embodiment, the F1 cables can be connected directly to the broadband distribution equipment 300 as illustrated by the connection at terminals 310 and 312. The F1 terminals 310 and 312 are also connected to F2 terminals 311 and 313 that correspond to subscribers. Alternatively, the various F1 cables can be connected to the F2 cables, which are further connected to the broadband distribution equipment 300. For example, the F1 cable terminals 314 and 316 are shown connected to F2 cable terminals 318 and 320, respectively, which are further connected to the broadband distribution equipment 300. In each of the embodiments discussed above, the broadband distribution equipment 300 is “tapped” to the respective F1/F2 connections resulting in a parallel impedance relationship that will be discussed in greater detail below.

As was discussed above, each of the F1 cables can be connected to respective F2 terminals and to broadband distribution equipment 300 even though the customer premises equipment corresponding to a particular F2 terminal may not be activated at the time the connection is initially established. Various users can subsequently be provided with DSL service by remotely activating the broadband service without the need to have a technician physically return to the cross-connect box, thereby reducing the cost of provisioning DSL service.

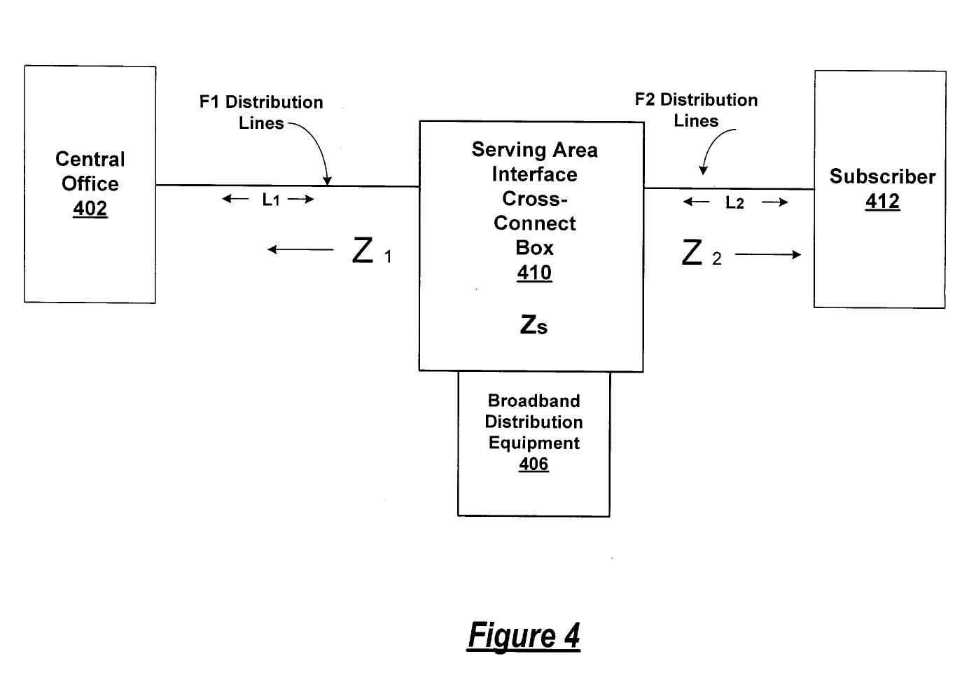

FIG. 4 is a generalized illustration of the equivalent impedances resulting from line lengths of the F1 and F2 distribution cables connected to the serving area interface (SAI) cross-connect box 410 in the subscriber distribution area. The SAI has a source impedance ZS. The impedance of the portion line from the SAI to the central office 402 is Z₁. The impedance of the portion of the line from the SAI to the customer premises equipment of the subscriber 412 is Z₂.

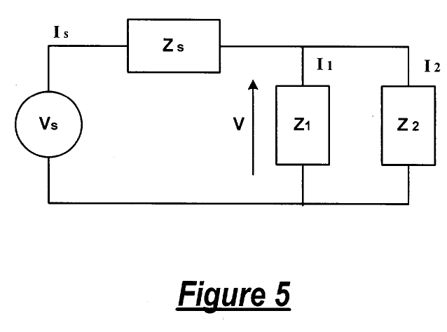

FIG. 5 is a schematic block diagram of the equivalent impedances of the serving area interface and the F1/F2 distribution cables connected to the broadband distribution equipment, via the cross-connect box, in the subscriber distribution area. The voltage V at the output of the SAI is given by the following equation:

$$V = \frac{{Z}_{1} {Z}_{2}}{{Z}_{s} {Z}_{1} + {Z}_{s} {Z}_{2} + {Z}_{2} {Z}_{1}} {V}_{S}$$

The currents I₁ and I₂ shown in FIG. 5B will be:

$${I}_{1} = \frac{{Z}_{2}}{{Z}_{S} {Z}_{1} + {Z}_{S} {Z}_{2} + {Z}_{2} {Z}_{1}} {V}_{S} , {I}_{2} = \frac{{Z}_{1}}{{Z}_{S} {Z}_{1} + {Z}_{S} {Z}_{2} + {Z}_{2} {Z}_{1}} {V}_{S}$$

Assuming that the system operates at broadband frequencies and the loop lengths L₁ and L₂ are long enough, the two impedances Z₁ and Z₂ are sufficiently close in magnitude that they can be considered to be equal and can be approximated by Z. The currents, therefore, will be:

$${I}_{1} = {I}_{2} = \frac{{I}_{S}}{2} = \frac{1}{2 {Z}_{S} + Z} {V}_{S}$$

Since the current is the same in both branches of the circuit the same amount of power will be transmitted upstream on the F1 branch and downstream on the F2 branch thereby resulting in a loss of only 3 dB in the upstream direction with the broadband distribution equipment tapped to the SAI connections as described hereinabove.

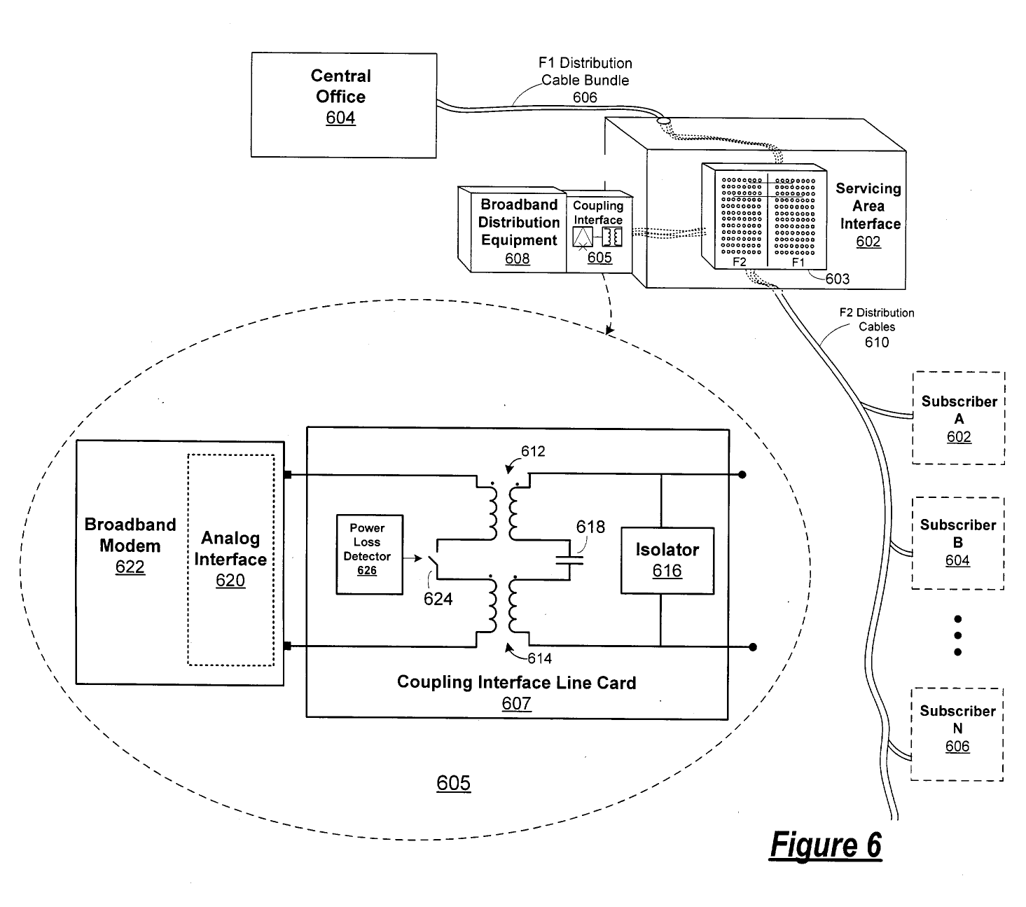

FIG. 6 is a block diagram illustration of the connection of broadband distribution equipment to the junction of the F1/F2 distribution cables in the SAI via a coupling system that is operable to maintain proper impedance operation of POTS equipment in the event of a loss of power to the system components of the coupling system. As discussed above in connection with FIGS. 2-5, the SAI 602 is operatively connected to the central office 604 via an F1 distribution cable bundle 606. Broadband data services are provided via broadband distribution equipment 608 that is connected to the junction of the F1/F2 distribution cables within the SAI 602 as described hereinabove. Subscriber A, subscriber B, . . . subscriber N, denoted by reference numerals 602, 604, and 606, respectively receive broadband data via F2 distribution cables 610.

The coupling system is broadly comprised of a pair of coupling transformers 612 and 614 having primary terminals connected to the F2 distribution cables. Isolator 616 provides isolation to protect against lighting, power cross and similar undesired interference signals. Additional isolation and DC blocking is provided by capacitor 618. The secondary terminals of the transformers 612 and 614 are connected to the analog interface 620 of the broadband modem 622.

The system shown in FIG. 6 presents several issues that must be addressed in connection with the simultaneous use of the coupling system to provide broadband services and POTS. One issue that must be addressed relates to the impedance needed to maintain POTS service. Standard POTS service is outside the broadband operating frequency range. In the coupling system of the present invention, frequency domain filtering causes the “tapped-on” interface of the coupling system 600 to appear as a high-impedance load to the POTS, thereby avoiding disruption of existing POTS service.

Another issue relates to services that occupy or overlap the broadband operating frequency range. Examples include existing XDSL services and T1 services. In situations where power to the coupling system circuitry is disrupted, “parasitic” current paths can be created in semiconductor devices in the coupling system components that would normally be held in reverse bias by the equipment power supply. Loss of power can result, therefore, in a nonlinear load across the tip and ring. This issue is addressed in the coupling system of the present invention by switch 624 connected between the secondary terminals of the transformers 612 and 614 as shown in FIG. 6. Upon loss of power to the coupling system 600, a power loss detector 626 causes switch 626 to open, thereby causing the coupling system to have an impedance that is compatible with continued operation of POTS equipment. The switch 624 can by implemented using numerous techniques known in the art. For example, the switch can be capacitively isolated, opto-isolated or magnetically isolated.

The method and apparatus of the present invention results in a dramatic reduction in required signal power, while ensuring a high quality of service to the subscriber. The impedance characteristics at the tapping point allow the broadband distribution system of the present invention to be deployed without the need for a POTS splitter to provide standard telephone service to the subscriber. The method and apparatus of the present invention has the advantage of significantly decreasing the cost and complexity associated with providing broadband service subscribers by tapping into the F1/F2 connections at the SAI.

In view of the above detailed description of the invention and associated drawings, other modifications and variations will now become apparent to those skilled in the art. It should also be apparent that such other modifications and variations may be effected without departing from the spirit and scope of the invention.

What is claimed is:

1. A broadband data services distribution system, comprising:
a broadband distribution unit for providing a broadband data signal;
a servicing area interface that is communicatively coupled to a central office via a first set of communication cables having a first impedance and communicatively connected to at least one customer premises equipment unit via a second set of communication cables having an impedance approximately equal to said first impedance of said first set of communication cables;
wherein said broadband distribution unit is connected to a junction of said first set of cables and said second set of cables, said data signal being operable to provide broadband data services to said customer premise equipment.

2. The distribution apparatus according to claim 1, said first set of cables comprising F1 distribution cables communicatively connected to a central office, said second set of cables comprising F2 distribution cables communicatively connected to said customer premises equipment.

3. The distribution apparatus according to claim 1 wherein said broadband distribution unit receives said broadband data signal via a plurality of dedicated F1 cables.

4. The distribution apparatus according to claim 1 wherein said broadband distribution unit receives said broadband data signal via a separate transmission link.

5. The distribution apparatus according to claim 4 wherein said separate transmission link comprises a fiber optic transmission link.

6. The distribution apparatus according to claim 4 wherein said separate transmission link comprises a fiber optic transmission link.

7. The distribution apparatus according to claim 1, wherein said broadband distribution unit is connected to said second set of cables via a coupling system having an impedance compatible with the operation of POTS service.

8. The distribution apparatus according to claim 7, wherein said coupling system comprises detection circuitry for monitoring the power supplied to said coupling system.

9. The distribution apparatus according to claim 8, wherein said detection circuitry is operable to open a switch upon loss of power to cause said coupling system to maintain an impedance compatible with operation of POTS service when power to said coupling system is disrupted.

10. A method of providing broadband data services to a subscriber, comprising:
forming a junction of a first set of communication cables and a second set of communication cables,
said first set of communication having a first impedance and being communicatively connected to a central office,
said second set of communication cables having an impedance approximately equal to said first impedance of said first set of communication cables, said second set of communication cables being communicatively connected to at least one customer premises equipment unit;
providing a broadband data signal to said junction of said first and second set of communication cables from a broadband distribution unit located at said junction of said first and second communication cables, said broadband data signal being transmitted to a subscriber via said second set of communication cables.

11. The method according to claim 10, said first set of cables comprising F1 distribution cables communicatively connected to a central office, said second set of cables comprising F2 distribution cables communicatively connected to said customer premises equipment.

12. The method according to claim 11 wherein said broadband distribution unit receives said broadband data signal via a plurality of dedicated F1 cables.

13. The method according to claim 12 wherein said broadband distribution unit receives said broadband data signal via a separate transmission link.

14. The method according to claim 13 wherein said separate transmission link comprises a fiber optic transmission link.

15. The method according to claim 13 wherein said separate transmission link comprises a fiber optic transmission link.

16. The method according to claim 10, wherein said broadband distribution unit is connected to said second set of cables via a coupling system having an impedance compatible with the operation of POTS service.

17. The method according to claim 16, wherein said coupling system comprises detection circuitry for monitoring the power supplied to said coupling system.

18. The method according to claim 17, wherein said detection circuitry is operable to open a switch upon loss of power to cause said coupling system to maintain an impedance compatible with operation of POTS service when power to said coupling system is disrupted.

19. A servicing area interface, comprising:
a cross-connect box having a first set of terminals and a second set of terminals, said first set of terminals being operably connected to a plurality of cable pairs in an F1 distribution cable bundle, said second set of terminals being operably connected to a plurality of cable pairs in an F2 distribution cable bundle;
a plurality of connectors for establishing electrical junctions between predetermined pairs of said first set of terminals and said second set of terminals; and
a broadband distribution unit operable to provide a broadband data signal, said broadband distribution unit being connected to a plurality of predetermined junctions between said first set of terminals and said second set of terminals.

20. The servicing area interface according to claim 19, said first set of cables comprising F1 distribution cables communicatively connected to a central office, said second set of cables comprising F2 distribution cables communicatively connected to said customer premises equipment.

21. The servicing area interface according to claim 19 wherein said broadband distribution unit receives said broadband data signal via a plurality of dedicated F1 cables.

22. The servicing area interface according to claim 19 wherein said broadband distribution unit receives said broadband data signal via a separate transmission link.

23. The servicing area interface according to claim 22 wherein said separate transmission link comprises a fiber optic transmission link.

24. The servicing area interface according to claim 22 wherein said separate transmission link comprises a fiber optic transmission link.

25. The servicing area interface according to claim 19, wherein said broadband distribution unit is connected to said plurality of junctions via a coupling system having an impedance compatible with the operation of POTS service.

26. The servicing area interface according to claim 25, wherein said coupling system comprises detection circuitry for monitoring the power supplied to said coupling system.

27. The servicing area interface according to claim 26, wherein said detection circuitry is operable to open a switch upon loss of power to cause said coupling system to maintain an impedance compatible with operation of POTS service when power to said coupling system is disrupted.
